(19) United States
(12) Patent Application Publication
(10) Pub. No.: US 2007/0149240 A1
(43) Pub. Date: Jun. 28, 2007

(54) Automatically establishing location groups

(76) Inventor: Jacco Brok, Overijssel (NL)

Correspondence Address: CARLSON, GASKEY & OLDS, P.C., 400 W MAPLE RD, SUITE 350, BIRMINGHAM, MI, 48009, US

(21) Appl. No.: 11/319,762

(22) Filed: Dec. 28, 2005

(51) Int. Cl. H04Q 7/20

(52) U.S. Cl. 455/524

(57) ABSTRACT

A method of establishing a location group includes using a cellular network cell (22, 24, 26) identifier and at least one other beacon (30, 32) concurrently detected by a mobile station (20). The location group includes an indication of the concurrently detected cell (22, 24, 26) identifier and at least one other beacon (30, 32). In a disclosed example, stored indications of all beacons (30, 32) currently detected are associated with each cell identifier that is added to the location group. Techniques for adding beacons and cell identifiers to established location groups are disclosed.

### FIELD OF THE INVENTION

This invention generally relates to communications. More particularly, this invention relates to wireless communications.

### DESCRIPTION OF THE RELATED ART

Wireless communication systems are well known and in widespread use. Cellular communication networks typically include a plurality of base stations geographically located to serve corresponding regions or cells. Mobile stations such as cell phones, personal digital assistants and laptop computers communicate using radio frequency signals through the base stations to a cellular network, which facilitates communications with other devices.

There are a variety of reasons to locate a mobile station or to determine information regarding an approximate location of a mobile station using information available from the mobile station, the network associated with the mobile station or both. It is possible to estimate a position of a mobile station based upon information regarding which cell is currently serving the mobile station because the geographic boundaries of a cell are generally known. There are various situations, however, in which more accurate information is required.

Additionally, there is a problem when a mobile station detects (e.g., is served by) one cell while in an area that is also covered or served by another cell. If information regarding a particular location is associated with one such cell but not the other, the mobile station location cannot be determined when the mobile station detects the other cell.

One example technique for locating a mobile station includes using global positioning system (GPS) data to geographically locate the mobile station. Some example techniques rely upon a GPS receiver to independently make such a determination. Another known approach is known as assisted GPS. This includes using information from a cellular network to estimate a mobile station location. Information regarding the estimate facilitates a modified GPS receiver on the mobile station obtaining GPS information useful for actually locating the device.

There are limits on GPS based approaches. Without assisted GPS, the location typically cannot be determined for several minutes, which is undesirably long in some situations. Standard GPS receivers are expensive and consume power at a relatively high rate. Additionally, GPS (standard or assisted) typically does not work when the receiver is indoors because the receiver cannot communicate effectively with the GPS satellites.

Another approach includes providing a mobile device with a capability to detect more than one cellular network cell identifier at one time. This approach has not gained much popularity and, therefore, has limited usefulness. Most mobile stations are limited to being able to detect only one cell identifier at any one time.

Another approach includes obtaining a history of cell identifiers seen by a mobile station over a long period of time. The publication, K. Laasonen, M. Raento, H. Toivonen: Adaptive On-Device Location Recognition, Proceedings of PERVASIVE 2004, Second International Conference on Pervasive Computing, Vienna, Austria (2004), describes one such approach. There are limitations associated with such a history-based approach. It typically requires several weeks to obtain enough history to make any reasonably reliable conclusion based on such history information. It requires at least several days in many situations. Additionally, this approach is subject to errors.

There is a need for an improved technique for providing location information regarding a mobile station. This invention addresses that need.

### SUMMARY OF THE INVENTION

An exemplary method of communicating includes establishing a location group responsive to a mobile station concurrently detecting a cellular network cell identification and detecting at least one beacon that is different from a cellular network cell.

One example includes storing an indication of the cell identifier and an indication of the at least one beacon within the location group. The indication of the at least one beacon includes an associated indication of a cell identifier for a cell that is detected concurrently with each beacon.

One example includes adding additional beacons to a location group when a new one is detected while a mobile station is within an established location group area. In one example, the current location group is identified based on the currently detected cell identifier.

One example includes adding an additional cell identifier to a location group when a new one is detected. The current location group is identified based on at least one of the beacons currently detected. In one example, if the at least one beacon is part of a location group and the at least one beacon has an associated cell identifier for all cells that are part of that location group, then the newly detected cell identifier is added to that location group.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a communication arrangement including a plurality of cellular network cells, a plurality of beacons and a mobile station that has cell identifier detection capability and at least one type of beacon detection capability.

FIG. 2 is a flowchart diagram summarizing one example approach that is useful in an embodiment of this invention.

### DETAILED DESCRIPTION

This invention allows for automatically establishing location groups responsive to a mobile station detecting at least one cellular network cell identifier and at least one beacon that is different than a cell identifier.

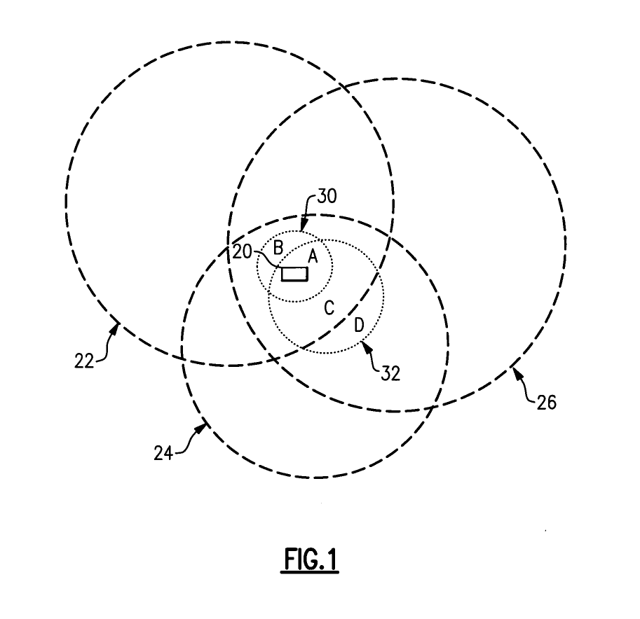

FIG. 1 schematically shows an example mobile station 20 that may be a cellular phone, personal digital assistant or a notebook or laptop computer, for example. This invention is not necessarily limited to any particular type of mobile station. The mobile station 20 is schematically shown located relative to coverage areas or communication ranges for cellular network cells 22, 24 and 26. In this example, the cells 22, 24 and 26 have overlapping coverage areas. Each cell has at least one base station (not illustrated) that facilitates communications on behalf of the mobile station 20 and a cellular network (not illustrated) in a generally known manner.

The example mobile station 20 is also schematically shown located relative to communication ranges or coverage areas of beacons 30 and 32. Each beacon may be a device that can be detected by the mobile station 20 when the mobile station 20 is within the corresponding range or coverage area of the beacon. Each beacon in one example is stationary or fixed to a known (or discernable) location. The example beacons comprise devices that are different than those used for the cells 22, 24 and 26. As schematically shown, the beacons 30 and 32 have a communication range that is much smaller than that of each of the cells 22, 24 and 26.

One example beacon comprises an IEEE 802.11 wireless fidelity (Wi-Fi) access point. In such an example, the mobile station 20 has Wi-Fi capability that enables the mobile station 20 to at least detect the presence of the corresponding beacon when the mobile station 20 is within the coverage area or range of the Wi-Fi access point.

Another example beacon is a radio frequency identifier tag or reader. In such an example, the mobile station 20 includes a radio frequency identifier recognition module that works in a known manner. When the mobile station 20 is within an appropriate range of such a beacon, the mobile station can detect the radio frequency identifier (RFID).

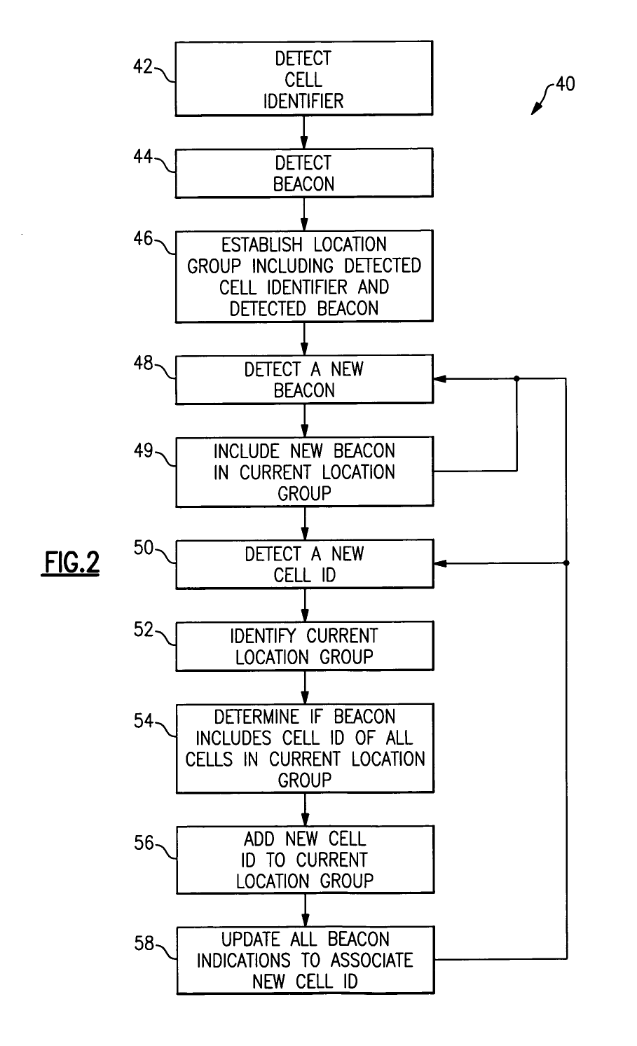

FIG. 2 includes a flowchart diagram 40 summarizing one example approach for establishing location groups. This example begins at 42 where the mobile station 20 detects a cell identifier. This occurs, for example, when the mobile station is served by or establishes a communication link with an appropriate base station associated with one of the cells 22, 24 or 26.

At 44, the mobile station 20 detects at least one of the beacons 30 or 32. For purposes of discussion, assume that the mobile station only detects the beacon 30 at a particular time that is concurrent with detecting the cell identifier of the cell 22.

At 46, a location group is established that includes the beacon 30 and the cell identifier for the cell 22. In this example an indication of the beacon 30 and an indication of the cell identifier for the cell 22 is stored as part of the location group information. The location group information may be stored in a variety of locations. One example includes maintaining the location group information in a database that is stored on the mobile station. In such an example, a mobile station can gather information regarding cell identifiers and beacons, establish location groups and quickly determine its position especially for frequently visited areas. At the same time, the mobile station does not require an ability to store large amounts of information. This is one of the advantages of the example embodiment.

Another example includes a centralized database within a cellular network that includes the cells 22, 24 and 26. An appropriate portion of the network may be used such that information regarding locations of mobile stations relative to beacons and cells can be included in the database and then made available as needed for the network or mobile stations, for example.

Location group information in the database may, but need not necessarily, include actual geographic location information regarding the area corresponding to the location group. If such information is needed, known mapping techniques (e.g., network ID to location coordinates) are used in one example. Those skilled in the art who have the benefit of this description will realize how to arrange a database including location groups established according to an embodiment of this invention to meet their particular needs.

The example of FIG. 2 includes associating the cell identifier with the indication of the beacon 30 within the information stored for the location group.

At 48, the other beacon 32 is detected and added to the location group at 49. In one example, adding a beacon to an established location group is based upon identifying the current location group that includes the position of the mobile station 20 by cell identifier. The current cell identifier detected by the mobile station 20 (e.g., for cell 22 in this example) provides an indication of the current location group. An indication of the beacon 32 is added to the current location group. One example includes associating an indication of the currently detected cell identifier with the indication of the newly added beacon indication.

From time to time, the cell identifier detected by a mobile station will change. This may occur, for example, when there is a handoff between cells. The illustrated example includes detecting a new cell identifier at 50. In one example, at least one currently detected beacon is used to identify the current location group at 52. At 54, the at least one currently detected beacon is checked to determine whether the indication of that beacon stored within that location group includes an associated indication of all cell identifiers that are already part of that location group. For example, if the newly detected cell identifier is for the cell 24 and the beacon 30 is used to locate the current location group, then the determination at 54 includes confirming that the indication of the beacon 30 has an associated indication of the identifier for the cell 22. If that determination is positive, then the newly detected cell identifier (i.e., for the cell 24) can be added to the current location group at 56.

In this example, a location group can include more than one cell identifier. Whenever a new cell identifier is added to a location group, all beacons that are currently detected by the mobile station and are part of that group are given an associated indication of the newly added cell identifier at 58.

Assuming that some time later, the mobile station detects the cell 26, the process at steps 50-58 repeats for the cell 26. In this example, the indication of the beacon used to locate the current location group must have an associated indication of the cells 22 and 24 (because they are already part of the example location group as described above). If the determination at 54 is positive, then the identifier for the cell 26 is added to the location group at 56 and all currently detected beacons are updated to have an associated indication of the newly added cell identifier at 58.

In the illustrated example, once the beacons 30 and 32 and the three cells 22, 24 and 26 are included in the current location group, that location group has all the information regarding it within the database. If the mobile station moves into another location that changes which of the beacons or which of the cells that the mobile station can detect, then a new location group can be formed in a manner similar to that described above.

The example technique of adding a newly detected cell identifier to an established location group only after verifying that the beacon indication used to identify a candidate location group includes all cell identifiers of that group prevents a location group from growing infinitely if new cell identifiers and new beacons are repeatedly detected in an alternating fashion. Associating all existing cell identifiers within a location group with all currently detected beacons provides a mechanism to obtain convergence for establishing the bounds of a location group. In effect, new cell identifiers can only be added to a location group if any of the currently detected beacons have also been detected in the past and associated with all of the cell identifiers that are already in that location group.

Once location groups are established, it is possible to determine an approximation of a mobile station location by determining which location group or groups includes the cell identifier currently detected by the mobile station. Detecting beacons is not necessary to determine a location group for a mobile station provided that the mobile station can at least detect a current cell identifier.

There may be situations when a cell identifier is included in more than one location group and then information regarding one or more currently detected beacons can be used to more accurately determine which location group covers the area that includes the mobile station's current location.

In FIG. 1, the areas labeled A, B, C and D may each comprise an area corresponding to a different location group. This will depend on distances between the edges of beacon ranges and the sensitivities of the mobile station. In some examples, the granularity of location groups will not be high enough to distinguish the areas labeled A, B and C as different locations for purposes of establishing them as distinct location groups.

Assuming that the physical relationship among the ranges schematically shown in FIG. 1 is such that the differently labeled areas can be distinguished from each other for purposes of determining distinct location groups, the area labeled A corresponds to a location group established using the example technique described above. That location group includes the cells 22, 24 and 26 and the beacons 30 and 32. The area labeled B corresponds to a location group that includes all three illustrated cells 22, 24 and 26 but only beacon 30 because beacon 32 cannot be detected in that area. The area labeled C corresponds to a location group that includes all three cells 22, 24 and 26 but only beacon 32. The area labeled D corresponds to a location group that includes the cells 24 and 26 and beacon 32.

Assuming that any of the cells 22, 24 or 26 is currently detected, it may not be possible to exactly determine which location group corresponds to the mobile station location without also determining whether either or both of the beacons 30 and 32 are currently detected in this example.

The example method of establishing location groups has a variety of unique features. The example technique does not require knowledge of the actual location of the mobile station such as GPS or other coordinate-based data, a table that maps cell identifiers to location coordinates or address information. The example method does not require knowledge regarding the detected beacons other than the fact that they typically have a smaller range than a cell and that the beacons typically remain in a fixed position for at least a considerable amount of time. The example method also ensures convergence in that only cells that can be detected within range of a currently detected beacon can become part of a location group.

The example method also provides several advantages. There is no need to provide a mobile station with special capabilities like GPS or multiple cell detection capabilities. Instead, a combination of beacon detection, which is already being included on many mobile stations, and single cell identifier detection, which already is present on mobile stations, allows for forming location groups. This provides cost savings as additional devices need not be included in a mobile station and power consumption can be minimized.

Another advantage is that no input from an individual user is required. The entire process can be automated and occurs without any knowledge of or participation by the user or owner of the mobile station.

Another advantage provided by the example method is that there is an instantaneous response upon a change in the detected cell identifier, provided that beacon detection is enabled at the time of the cell change. There is no requirement to track information over long periods in hopes of establishing a history from which to draw location information.

The example method allows for utilizing various functions within a wireless communication network including setting a user's role, activity or type of place; adjusting a user's privacy settings; handling voice, multimedia and message sessions differently; starting applications; sending messages or alarms; or a combination of two or more of these.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising
establishing a location group responsive to a mobile station concurrently detecting a cellular network cell identification and detecting at least one beacon that is different from a cellular network cell.

2. The method of claim 1, comprising
storing an indication of the cellular network cell as part of the location group;
storing an indication of the at least one beacon as part of the location group.

3. The method of claim 2, comprising
associating an indication of the cellular network cell with the stored indication of the at least one beacon.

4. The method of claim 1, comprising
adding at least one other beacon to the established location group responsive to the mobile station concurrently detecting the at least one other beacon and detecting the cellular network cell identification.

5. The method of claim 4, comprising
identifying the location group that includes the cell identification currently detected by the mobile station; and
adding the at least one other beacon to the identified location group.

6. The method of claim 4, comprising
associating an indication of the cell identification currently detected by the mobile station with an indication of the at least one other beacon within the location group.

7. The method of claim 1, comprising
adding at least one other cellular network cell identification to the established location group responsive to the mobile station concurrently detecting the at least one beacon and detecting the at least on other cellular network cell identification.

8. The method of claim 7, comprising
identifying the location group that includes the detected at least one beacon; and
adding the at least one other cellular network cell identification to the identified location group.

9. The method of claim 7, wherein each beacon within a location group has at least one associated cell identification indicating at least one corresponding cell identification previously detected concurrently with detecting each beacon, respectively and comprising
determining all cell identifications within the identified location group; and
adding the at least one other cellular network cell identification to the identified location group only when the detected at least one beacon has an associated cell identification for all of the determined cell identifications within the identified location group.

10. The method of claim 7, comprising
associating an indication of the at least one other cellular network cell with the detected at least one beacon within the established location group.

11. The method of claim 1, wherein the at least one beacon has a known location.
